(19) United States
(12) Patent Application Publication
(10) Pub. No.: US 2024/0078105 A1
(43) Pub. Date: Mar. 7, 2024

(54) DEVICE HAVING AN E-INK DISPLAY

(71) Applicant: Murrelektronik GmbH, Oppenweiler (DE)

(72) Inventors: Henrik RUF, Oppenweiler (DE); Ingo WOLFF, Oppenweiler (DE)

(21) Appl. No.: 18/242,625

(22) Filed: Sep. 6, 2023

(30) Foreign Application Priority Data
Sep. 7, 2022 (DE) 10 2022 122 716.2

(51) Int. Cl. G06F 8/65

(52) U.S. Cl. CPC G06F 8/65

(57) ABSTRACT

A device including at least a memory, a processor and an e-ink display, wherein the processor is configured and set up to read out service information from the memory, generate a machine-readable code based on the service information, and transmit the machine-readable code to the e-ink display such that the e-ink display displays the machine-readable code which, when read using a terminal, causes the terminal to retrieve the service information. A method of operating a device having an e-ink display.

### FIELD OF THE DISCLOSURE

Embodiments of the present disclosure relate to a device having an e-ink display and to a method of operating a device having an e-ink display.

### BACKGROUND

Nowadays, machines and systems are mostly designed in a computer-aided manner, in particular by means of a design program, which is also referred to as CAD software. During the planning phase, digital images of a real machine or system are created as a set of drawings, parts lists and other data. During machine design, individual components of the machine or system are in most cases labeled. This labeling often remains on the respective component throughout the entire life cycle. The labeling can carry different information, for example a name of the component, which creates a reference to the other documents.

In particular, it may be advantageous for maintenance personnel to access such labeling to be able to establish a reference between the real component and the set of documents and/or to obtain service information about the component.

Labeling tags are usually used for labeling the components. These can be labeled manually or using special printers. The labeling can also be applied directly to the respective components, for example stamped or printed thereon, so that it is unchangeable.

This type of component labeling is complex and therefore costly. In addition, errors may occur when components are replaced or updated. If, for example, a new software version is installed on the component and the labeling is not adapted, this may lead to errors or at least increased effort during future maintenance work.

The object is to eliminate the drawbacks known from the prior art in a simple and cost-effective manner.

### SUMMARY

The object is achieved by a device comprising at least a memory, a processor and an e-ink display, wherein the processor is configured and set up to read out service information from the memory, generate a machine-readable code based on the service information, and transmit the machine-readable code to the e-ink display such that the e-ink display displays the machine-readable code. When the machine-readable code is read using a terminal, the latter is caused to retrieve the service information.

In this context, the term “retrieve” is understood to mean that the terminal receives the service information. This may be done in that the service information is directly contained in the machine-readable code, read by the terminal and decoded. Alternatively, reading the machine-readable code may cause the terminal to release an interface and/or open a link via which the service information reaches the terminal. Subsequently, the content of the service information may be displayed by the terminal.

The term “service information” is understood to mean various types of information about the device, in particular information required for maintenance purposes by maintenance personnel for maintenance. This includes detailed information about the device, its operating status and its technical condition. Non-exhaustive examples of service information are the name of the device, its place of use, its software and hardware status, its configuration, its technical condition (“health status”), address information and/or traceability data of the device, for example the manufacturing date or the serial number.

The basic idea is to make service information concerning a device or component retrievable via a display, so that a terminal can obtain the service information. For this purpose, the machine-readable code is displayed. The machine-readable code is not understandable to a human, so that a human cannot directly acquire the service information based on the machine-readable code.

However, conventional displays are not suitable for displaying the machine-readable code because they can only display the latter when it is switched on. However, the service information that can be retrieved via the machine-readable code is particularly important in the event of service, i.e. in a situation in which the system or machine is in most cases switched off, for example due to a defect.

In contrast to conventional displays, an e-ink display can show the information even when no electrical power is available, i.e. even in the event of a defect.

Since the available space for such labeling purposes, especially for the e-ink display on the device, is mostly limited, but service personnel often needs a variety of information for maintenance, a machine-readable code is provided by means of which the information can be retrieved and thus made available to service personnel in a technically simple manner. For this purpose, the machine-readable code is detected or read by means of the terminal to access the multitude of maintenance information despite the smaller space.

The terminal may be, for example, a portable computer and/or a smartphone. The machine-readable code may in particular be an optically detectable code such as a QR code, a bar code or the like.

A further advantage, which is achieved by the e-ink display in combination with the machine-readable code, is that the information can be easily adapted and/or changed electronically as often as desired, for example when the device or a device software is updated. Thus, the information provided is not static, as would be the case if the device were provided with an embossing or imprint.

According to one aspect, the service information may include data about a software version and/or about a configuration and/or about an operating time and/or about a manufacturing date of the device and/or about a fault that has occurred on the device. With respect to the last-mentioned aspect, it may also be provided that the device is configured, in the event of a shutdown due to an error, for example due to an undervoltage, to store error information during the shutdown process and/or to output error information via the e-ink display by means of the machine-readable code. It has been shown that it is precisely this data that is particularly important for maintenance personnel in the event of servicing. By retrieving the machine-readable code, time can be saved which would otherwise be needed to obtain the information elsewhere.

In a preferred embodiment, the processor is configured and set up to display the machine-readable code for a limited time via the e-ink display. This can provide time-limited access to the service information. It is thus ensured that only authorized users gain access to the service information within a certain period of time, which generally increases data security.

Furthermore, it is also conceivable that the machine-readable code is designed and/or encrypted such that only authorized users having appropriate reading technology and/or decryption technology can retrieve the service information. This also contributes to data security. The machine-readable code may further be designed such that a password must be entered to gain access to the service information. Likewise, decryption software may be provided in the terminal to decrypt the encrypted service information.

A further aspect provides that the device includes a digital communication unit. When the machine-readable code is read using the terminal, the latter is caused to establish a connection with the digital communication unit via an interface. The interface may be, for example, an interface for a WiFi, Bluetooth or other, preferably wireless, connection. Via the interface, the service information, software and/or other data can be transmitted between the device and the terminal in a technically simple manner.

Alternatively or additionally, a communication of the device with the terminal and/or with further components via a field bus is also conceivable. For example, information can be transmitted to the processor and/or to the e-ink display via this field bus.

To further increase data security, it is conceivable that the communication unit is configured and set up to maintain the connection for a limited time.

In addition, the device may be configured such that the connection is established even when the device is in a currentless or de-energized state. For this purpose, the terminal may provide energy via the interface, for example inductively, to establish the connection.

In particular, the communication unit may be a near-field communication unit. When the terminal reads the machine-readable code, it is caused to transmit service information and/or a software and/or a configuration from the memory to the terminal and/or from the terminal to the memory by means of the near-field communication unit. In this way, larger amounts of data may be transmitted in a technically simple manner. For example, a software update for the device and/or a display update for the ink display can be transmitted from the terminal to the memory by means of the near field communication unit. Conversely, software, for example, may also be transmitted from the device to the terminal and from there to a replacement device. Thus, in the event of a defect, the device can be easily replaced by the appropriately adapted replacement device.

It may further be provided that the processor is configured and set up to output at least part of the service information, in particular a software version and/or a configuration and/or a port label and/or operating time information and/or error information and/or a last manual access in a human-readable manner via the e-ink display.

For example, maintenance personnel can easily determine whether maintenance is necessary and/or whether maintenance is scheduled for the device without having to scan the machine-readable code for this purpose, i.e., read it using the terminal.

For example, the operating time information may be represented in the form of a bar on the e-ink display. For devices for which the maximum lifetime is provided and/or known, a prediction of the probable failure can thus be generated and displayed in a visually easily detectable manner.

Furthermore, it is also conceivable that further information is displayed in text form, in particular information identifying the device for service personnel. This includes, for example, IP addresses, safety addresses and/or free text describing the device.

Alternatively or additionally, an address to a digital instance or to a type twin may also be displayed, in particular in the form of a QR code.

Furthermore, the object is achieved by a method of operating a device comprising at least a memory, a processor and an e-ink display, comprising the following steps:
reading out service information from the memory using the processor,
generating a machine-readable code by means of the processor based on the service information,
transmitting the machine-readable code to the e-ink display,
displaying a machine-readable code on the e-ink display;
reading the machine-readable code using a terminal, wherein the terminal receives the service information and/or is caused to retrieve the service information by the reading.

The advantages and features already discussed above with respect to the device according to embodiments of the present disclosure of course also apply accordingly to the method according to the present disclosure.

In one embodiment, reading the machine-readable code causes the terminal to output the retrieved service information, in particular to display it on a screen. This makes the service information easily accessible to a user, such as maintenance personnel.

Alternatively or additionally, reading the machine-readable code can cause the terminal to copy software and/or a configuration and/or the retrieved service information present on the device, in particular to a replacement device. Thus, in the event of a defect, a replacement device can be set up comparatively easily so that the defective device can be replaced, i.e., can be replaced by a device that has already been set up. This reduces the maintenance effort and the time required for maintenance. In particular, downtime of a higher-level system is avoided or at least minimized, since a replacement device can be provided directly in the set-up and configured state.

The service information retrieved by the terminal can be retrieved from the device itself and/or from an external server structure, for example a cloud. Retrieval from the device itself has the advantage that no external connection of the terminal is required. In contrast thereto, retrieval from the external server structure has the advantage that the service information can be retrieved even without an electrical power supply and/or functional memory of the possibly defective device.

It may also be provided that the machine-readable code, when read using the terminal, causes the terminal to retrieve and/or display a digital twin of the device, for example by opening a URL. The digital twin may in particular be a standardized digital representation of the device, for example a so-called “Admin Administration Shell” (AAS). The digital twin provides maintenance personnel with lots of information that can be used, for example, to check the compatibility of the device with new software and/or other components. This allows problems to be identified and/or prevented at an early stage during maintenance.

In the event that the device is a component of a machine or system, the digital twin or the address information thereof can be used to also update a digital version of the machine or system when the device is replaced or updated. For this purpose, the machine-readable codes of the defective device as well as a replacement device may for example be scanned, as a result of which an association of the device with the replacement device is established. This reduces the risk of inconsistency between the real machine and/or system and the digital image thereof.

### BRIEF DESCRIPTION OF THE DRAWINGS

Further features and advantages of the present disclosure will become apparent from the description below and from the drawings, to which reference is made and in which:

FIG. 1 shows a schematic three-dimensional representation of an example embodiment of a device according to the present disclosure; and

FIG. 2 shows a schematic representation of a method according to an embodiment of the present disclosure.

### DETAILED DESCRIPTION

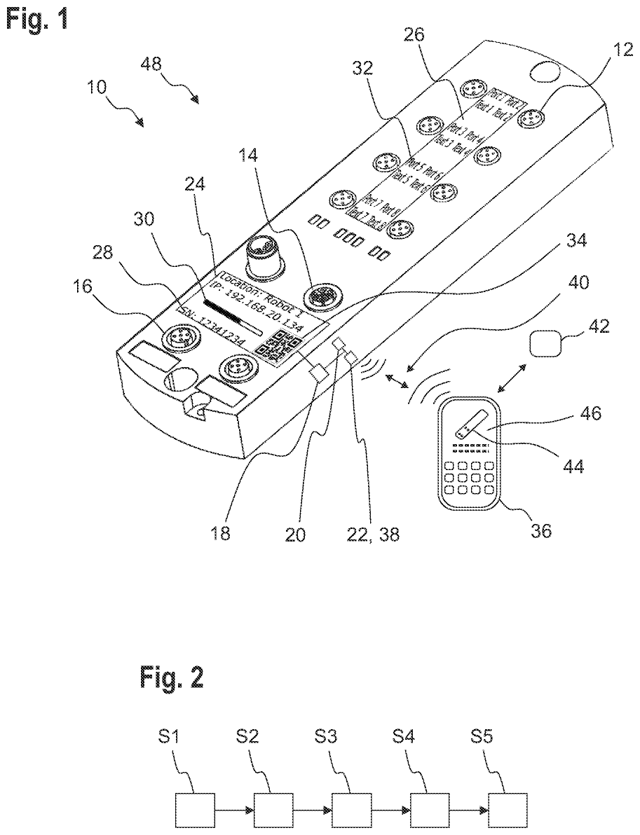

FIG. 1 shows a schematic three-dimensional representation of a device 10.

The device 10 is an IO-Link master, which in the example embodiment forms a central component of an IO-Link system (not shown).

The device 10 comprises a plurality of ports 12 for connecting IO-Link devices (not shown). Furthermore, the device 10 comprises supply ports 14, in particular for supplying electrical power, and communication ports 16, for example a fieldbus port.

Furthermore, the device 10 comprises a processor 18, a memory 20, and a digital communication unit 22 provided within a housing of the device 10.

The device 10 also includes a first e-ink display 24 and a second e-ink display 26 arranged on the housing so as to be accessible from the exterior 10, such that the displays 24, 26 are accessible from the exterior.

The memory 20 stores service information. In particular, the memory 20 may be a non-volatile memory so that the service information is not lost if, for example, electrical power is not available to the device 10 due to a defect and/or a shutdown.

In the example embodiment, the service information includes a plurality of data, in particular about a serial number 28 of the device 10 (“S/N”), a version and configuration of a system software of the device 10, a manufacturing date of the device 10, an operating time of the device 10, a last maintenance of the device 10, IO-Link devices connected to the device 10, faults which have occurred previously on the device 10, and addresses via which further information about the device 10 can be obtained.

The processor 18 is configured and set up to output part of the service information in a human-readable manner via one of the e-ink displays 24, 26.

As shown in FIG. 1, the first e-ink display 24 displays information about the serial number 28. The operating time is displayed in the form of a bar 30.

The second e-ink display 26 uses port labels 32 to display which IO-Link devices are connected to the respective ports 12. The port labels 32 thus also represent service information in the sense of the present disclosure.

The human-readable outputs enable users, in particular maintenance personnel, to quickly and easily acquire relevant information and thus better assess whether or when maintenance or replacement of the device 10 is necessary and how to proceed in the event of maintenance, for example how to reconnect the device 10 after maintenance.

The processor 18 is further configured and set up to read out the service information from the memory 20, generate a machine-readable code 34 based on at least part of the service information, and transmit the machine-readable code 34 to the first e-ink display 24 so that the latter displays the machine-readable code 34.

In the example embodiment, the machine-readable code 34 is a QR code. Of course, this is not to be understood in a restrictive manner. Other types of machine-readable codes 34 are also conceivable, for example bar codes.

The machine-readable code 34 is designed to cause a terminal 36, for example a computer or smartphone, to retrieve the service information when it is read or scanned by it. The retrieval may in particular be performed by means of the communication unit 22 of the device 10.

In the example embodiment, the communication unit 22 is a near-field communication unit 38.

Reading the machine-readable code 34 causes the terminal 36 to establish a connection 40 with the device 10, for example with the communication unit 22 of the device 10, and to read out the service information from the memory 20 via this connection 40. For this purpose, the terminal 36 has an appropriate interface which can communicate, for example, with the communication unit 22 of the device 10.

The connection 40 can also be used to transmit or copy the system software and/or configuration data to the terminal 36.

Reverse data transfer from the terminal 36 to the device 10 by means of the connection 40 is also possible. For example, during maintenance, the service information of the device 10 can be updated and stored in the memory 20 thereof. Thus, there may be a unidirectional connection 40 in any direction or a bidirectional connection 40.

Alternatively or additionally, reading the machine-readable code 34 may also cause the terminal 36 to retrieve service information from and/or transmit service information to an external server structure 42.

In particular, it is conceivable that address information, such as a URL, is transmitted to the terminal 36 by reading the machine-readable code 34. By communicating with the server structure 42, the terminal 36 can then open the corresponding URL and access and retrieve further information, for example a digital twin 44 of the device 10, and/or display it on a screen 46.

In the exampled embodiment, the processor 18 is configured and set up to output the machine-readable code 34 in a time-limited manner via the first e-ink display 24. Further, the communication unit 22 is configured and set up to maintain the connection 40 for a limited time.

This reduces the risk of unauthorized persons gaining access to the service information, the security of the device 10 and/or protection against attacks being thus improved.

In the example embodiment, the device 10 is operated using a method according to an embodiment of the present disclosure. The method steps are shown schematically in FIG. 2.

In the example described, the method shown is used for maintenance of the IO-Link system comprising the device 10 (the IO-Link master). Of course, this is not to be understood in a restrictive manner. In particular, the method can also be used for maintenance purposes of other types of devices and/or for information gathering in general.

During maintenance, maintenance personnel (not shown) first examines the device 10, in particular the human-readably displayed information on at least one of the e-ink displays 24, 26.

In a first step S1 of the method, the processor 18 reads at least one piece of service information from the memory 20. The service information includes, among other things, further address information via which the digital twin 44 of the device 10 can also be accessed via the external server structure 42.

Subsequently, in a second step S2, the processor 18 generates a machine-readable code 34 based on the service information.

In a third step S3, the machine-readable code 34 is transmitted to the first e-ink display 24.

In a fourth step S4, the machine-readable code 34 is displayed on the first e-ink display 24.

In a fifth step S5 of the method, the service personnel scans the machine-readable code 34 using the terminal 36. In the example embodiment, the service information is included in the machine-readable code 34. It reaches the terminal 36 by being read, is decoded there, and subsequently displayed on the screen 46, for example in text form.

Alternatively or additionally, it may also be provided that the reading of the machine-readable code 34 causes the terminal 36 to establish the previously described connection 40 with the device 10. Via the connection 40, the service information of the device 10 may be retrieved and displayed on the screen 46.

In the example embodiment, it is found that a fault has occurred requiring replacement of the device 10.

Through the retrieved service information and/or from the digital twin 44, the system software version and configuration of the device 10 are known, which can or are to be transferred to an appropriate replacement device 48 (in the example embodiment, identical in construction to device 10) for replacement purposes.

Via the connection 40, the software with the corresponding configuration can, for example, first be transmitted or copied from the device 10, in particular the memory 20, to the terminal 36 and from there to the replacement device 48. Alternatively, the software and/or configuration may also be transmitted directly from the external server structure 42 to the replacement device 48.

Subsequently, the device 10 can be easily replaced by the replacement device 48. As a result, the time required for maintenance and the maintenance effort are low.

1. A device comprising at least a memory, a processor, and an e-ink display, wherein the processor is configured and set up to read out service information from the memory, generate a machine-readable code based on the service information, and transmit the machine-readable code to the e-ink display such that the e-ink display displays the machine-readable code which, when read using a terminal, causes the terminal to retrieve the service information.

2. The device according to claim 1, wherein the service information comprises data about a software version and/or about a configuration and/or about a fault that has occurred on the device and/or about an operating time and/or a manufacturing date of the device.

3. The device according to claim 1, wherein the processor is further configured and set up to display the machine-readable code in a time-limited manner via the e-ink display.

4. The device according to claim 1, further comprising a digital communication unit, wherein the machine-readable code, when read using the terminal, further causes the terminal to establish a connection with the communication unit.

5. The device according to claim 4, wherein the communication unit is configured and set up to maintain the connection for a limited time.

6. The device according to claim 4, wherein the communication unit is a near field communication unit, wherein the machine-readable code, when read using the terminal (36), further causes the terminal to transmit service information and/or a software and/or a configuration by means of the near field communication unit from the memory to the terminal and/or from the terminal to the memory.

7. The device according to claim 1, wherein the processor is further configured and set up to output at least part of the service information in a human-readable manner via the e-ink display.

8. The device according to claim 1, wherein the processor is further configured and set up to output a software version and/or a configuration and/or a port label and/or operating time information, in a human-readable manner via the e-ink display.

9. A method of operating a device comprising at least a memory, a processor and an e-ink display, comprising the following steps:
reading out service information from the memory using the processor,
generating a machine-readable code by means of the processor based on the service information,
transmitting the machine-readable code to the e-ink display,
displaying a machine-readable code on the e-ink display,
reading the machine-readable code using a terminal, wherein the terminal receives the service information and/or is caused to retrieve the service information by the reading.

10. The method according to claim 9, wherein the machine-readable code, when read using the terminal, further causes the terminal to output the retrieved service information.

11. The method according to claim 9, wherein the machine-readable code, when read using the terminal, further causes the terminal to display it on a screen.

12. The method according to claim 9, wherein the machine-readable code, when read using the terminal, further causes the terminal to copy software and/or a configuration and/or the service information present on the device.

13. The method according to claim 9, wherein the machine-readable code, when read using the terminal, further causes the terminal to copy software and/or a configuration and/or the service information present on the device to a replacement device.

14. The method according to claim 9, wherein the service information is retrieved from the device itself and/or from an external server structure.

15. The method according to claim 9, wherein the machine-readable code, when read using the terminal, further causes the terminal to retrieve and/or display a digital twin of the device.
